(19) United States
(12) Patent Application Publication
(10) Pub. No.: US 2014/0316930 A1
(43) Pub. Date: Oct. 23, 2014

(54) EXPLANATIONS FOR PERSONALIZED RECOMMENDATIONS

(71) Applicant: GOOGLE, INC., (US)

(72) Inventors: Ankit Jain, Milpitas, CA (US); Abhinav Khandelwal, Mumbai Maharashtra (IN)

(73) Assignee: GOOGLE, INC., Mountain View, CA (US)

(21) Appl. No.: 13/868,566

(22) Filed: Apr. 23, 2013

(51) Int. Cl. G06Q 30/06

(52) U.S. Cl. CPC G06Q 30/0631
USPC 705/26.5

(57) ABSTRACT

Generating and selecting recommendation explanations for personalized recommendations may include retrieving in response to at least one recommendation query, a document from a corpora of available documents for consumption by a user. The at least one recommendation query may be associated with a corresponding plurality of candidate recommendation explanations. The plurality of recommendation explanations for the document may be ranked based on popularity of at least one of the plurality of recommendation explanations when previously provided to the user and/or popularity of the document among a plurality of users under each of the plurality of recommendation explanations. The popularity of at least one of the plurality of recommendation explanations previously provided to the user may be based on document engagement history associated with the user when the at least one of the plurality of recommendation explanations were previously provided to the user.

### CROSS-REFERENCE TO RELATED APPLICATIONS

This patent application also makes reference to:

U.S. patent application Ser. No. ______ (attorney docket no. 25698US01), titled “LIVE RECOMMENDATION GENERATION,” and filed on the same date as this application;
U.S. patent application Ser. No. ______ (attorney docket no. 25699US01), titled “DETERMINING MEDIA CONSUMPTION PREFERENCES,” and filed on the same date as this application; and
U.S. patent application Ser. No. ______ (attorney docket no. 25700US01), titled “PERSONALIZED DIGITAL CONTENT SEARCH,” and filed on the same date as this application.

The above stated applications are hereby incorporated herein by reference in their entirety.

### BACKGROUND

Conventional recommendation engines are mainly based on a combination of offline processes, with sporadic lookups at query time. However, there are several drawbacks of such recommendation engines. For example, recommendations for all users have to be generated constantly, at regular time intervals, regardless of whether or not a user has returned to the recommendations destination. Additionally, since the recommendations are based on offline processes, the conventional recommendation engine does not take into account real-time feedback based on actions by the user. Furthermore, most conventional recommendations systems do not explain to the user, in detail, why a certain item is being recommended.

Further limitations and disadvantages of conventional and traditional approaches will become apparent to one of skill in the art, through comparison of such approaches with some aspects of the present method and apparatus set forth in the remainder of this disclosure with reference to the drawings.

### SUMMARY

A system and/or method is provided for generating and selecting recommendation explanations for personalized recommendations, substantially as shown in and/or described in connection with at least one of the figures, as set forth more completely in the claims.

These and other advantages, aspects and features of the present disclosure, as well as details of illustrated implementation(s) thereof, will be more fully understood from the following description and drawings.

In accordance with an example embodiment of the disclosure, a method is provided for generating and selecting recommendation explanations for personalized recommendations. The method for providing recommendations may include retrieving in response to at least one recommendation query, a document from a corpora of available documents for consumption by a user. The at least one recommendation query may be associated with a plurality of candidate recommendation explanations. The plurality of candidate recommendation explanations for the document may be ranked based on popularity of at least one of the plurality of recommendation explanations when previously provided to the user and/or popularity of the document when previously provided to a plurality of other users under at least one of the plurality of recommendation explanations.

In accordance with another example embodiment of the disclosure, a system for providing recommendations to a user may include a network device with at least one processor coupled to a memory. The at least one processor may be operable to retrieve in response to at least one recommendation query, a document from a corpora of available documents for consumption by a user. The at least one recommendation query may be associated with a plurality of candidate recommendation explanations. The at least one processor may be operable to rank the plurality of recommendation explanations for the document based on popularity of at least one of the plurality of recommendation explanations when previously provided to the user and/or popularity of the document when previously provided to a plurality of other users under at least one of the plurality of recommendation explanations.

In accordance with yet another example embodiment of the disclosure, a method for providing recommendations to a user may include retrieving in response to at least one recommendation query, a document from a corpora of available documents for consumption by a user. A plurality of candidate recommendation explanations associated with the document may be ranked based on at least one ranking criteria. The document may be provided with at least one top-ranked recommendation explanation to the user. The at least one top-ranked recommendation explanation may be selected from the plurality of candidate recommendation explanations. In response to selecting the at least one top-ranked recommendation explanation, a plurality of additional documents from the corpora of available documents may be provided to the user. The plurality of additional documents may correspond to the selected at least one top-ranked recommendation explanation.

### BRIEF DESCRIPTION OF THE DRAWINGS

FIG. 1 is a block diagram illustrating an example architecture for generating live recommendations with explanations, in accordance with an example embodiment of the disclosure.

FIG. 2A is a block diagram illustrating an example database with user-related information, which may be used during the live recommendation and explanation generation illustrated in FIG. 1, in accordance with an example embodiment of the disclosure.

FIG. 2B is a block diagram illustrating example explanations/user contexts, which may be used during the live recommendation and explanation generation illustrated in FIG. 1, in accordance with an example embodiment of the disclosure.

FIG. 3 is a block diagram illustrating a backend server architecture, which may be used during the live recommendation and explanation generation illustrated in FIG. 1, in accordance with an example embodiment of the disclosure.

FIG. 4 is a diagram illustrating example user recommendations with explanations, in accordance with an example embodiment of the disclosure.

FIG. 5 is a flow chart illustrating example steps of a method for providing recommendations with explanations to a user, in accordance with an example embodiment of the disclosure.

FIG. 6 is a flow chart illustrating example steps of another method for providing recommendations with explanations to a user, in accordance with an example embodiment of the disclosure.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “e.g.,” introduces a list of one or more non-limiting examples, instances, or illustrations. As utilized herein, the term “processor” may be used to refer to one or more of a central processing unit, a processor of a symmetric or asymmetric multiprocessor system, a digital signal processor, a micro-controller, a graphics/video processor, or another type of processor.

The present disclosure relates to a method and system for generating and selecting recommendation explanations for personalized recommendations. Conventional recommendation engines categorize the users into different categories and then suggest recommendations based on these categories. Additionally, conventional recommendation systems store the generated (or “processed”) user recommendations periodically for subsequent use. A user may browse through a list of such recommendations but the list may be exhaustive with a limited discovery of documents. Furthermore, most conventional recommendations systems today do not explain to the user, in detail, why a certain item is being recommended.

In accordance with an example embodiment of the disclosure, a search engine architecture may be used to provide real time recommendations with explanations across different content verticals with low latencies. The real time recommendations may be provided by storing multiple kinds of documents in the index and serving corpus of the search engine (e.g., documents that are about users as well as documents that are about items and their relations to different properties, such as which other items they are popular with, related to, as well as which regions or age groups they are popular in). The retrieval and ranking of the recommendations may then be separated into two phases, and only searching portions of the corpus (e.g., the various corpora or content verticals) that need to be searched.

More specifically, during a first phase, information about the user may be gathered. During a second phase, a “scatter gather” system may be used to retrieve a plurality of documents (e.g., apps, books, songs, movies, etc.) that the user can potentially be interested in, and then rank these retrieved items to generate recommendations for presenting to the user. A “scatter gather” system may include a single server (or a “root”), which may be operable to generate and communicate at least one document recommendation request or query to a plurality of other backend servers (or “leaves”) associated with a corpora (e.g., corpus 1, . . . , corpus N) of documents. For example, each corpus (1, . . . , N) may be associated with one or more of the “leaves”. Additionally, each of the “leaves” may be operable to retrieve and score/rank documents in response to the request or query received from the “root”. After the scoring/ranking of retrieved documents, the top documents from each “leave” may be returned to the “root”. The “root” may then gather, merge, and sort the documents from all of the “leaves” and return a final list of top results to the user. In this way, by using a “scatter gather” system, storing of “processed” user recommendations, which is typical of the conventional recommendation engines, may be avoided and all recommendation processing and presentation of the recommendations and the explanations to the user may be achieved in real time.

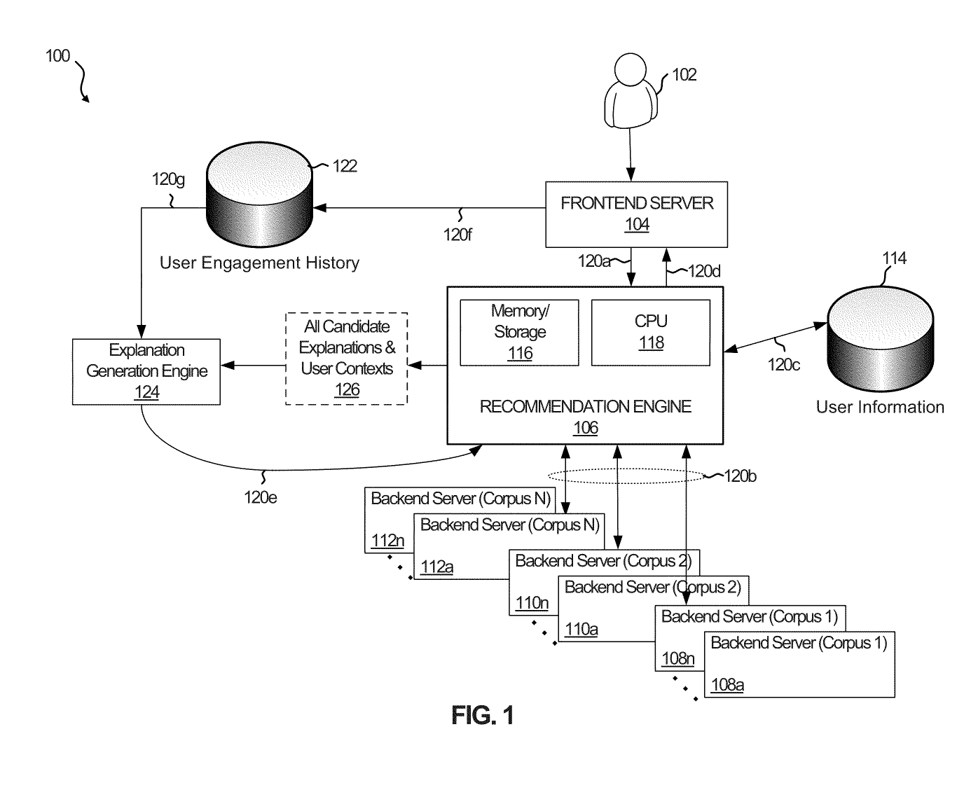

FIG. 1 is a block diagram illustrating an example architecture for generating live recommendations with explanations, in accordance with an example embodiment of the disclosure. Referring to FIG. 1, the architecture 100 may comprise a frontend server 104, a recommendation engine 106, a user information database 114, a plurality of backend servers 108a, . . . , 112n, user engagement history database, and an explanation generation engine 124.

The frontend server 104 may comprise suitable circuitry, logic and/or code and may be operable to provide a media consumption environment to the user 102. For example, the frontend server 104 may provide online media store functionalities (e.g., sale of songs, apps, books, movies, etc.), personal media locker services (cloud-based media storage) and other media-related functions.

The recommendation engine 106 may comprise memory/storage 116, CPU 118, as well as other suitable circuitry, logic and/or code, and may be operable to provide one or more recommendations to the frontend server 104 for presentation to the user 102. For example, the recommendation engine 106 may receive (e.g., via wired and/or wireless connection 120a) a request for a recommendation which may include user credentials (for user 102) from the frontend server 104 (e.g., after the user 102 logs in to a media web store or a media search engine maintained by the frontend server 104). The recommendation engine 106 may then receive user-related information (for user 102) from the user information database 114 via the wired and/or wireless connection 120c. The recommendation engine 106 may then generate one or more document recommendation requests or queries based on the received user-related information.

The generated document recommendation queries may be communicated to the backend servers 108a, . . . , 112n (e.g., via wired and/or wireless connections 120b), which may search one or more search corpus (e.g., corpus 1, . . . , N) and return a plurality of documents matching the document recommendation queries. The recommendation engine may then score each of the returned documents according to a pre-determined criteria or scoring algorithm, and then generate a final list of recommendations to be returned to the frontend server 104 for presentation to the user 102. In some instances, each of the backend servers 108a, . . . , 112n may retrieve and score/rank documents in response to the document recommendation queries received from the recommendation engine 106. After the scoring/ranking of retrieved documents, the top documents from each backend server 108a, . . . , 112n may be returned to the recommendation engine 106.

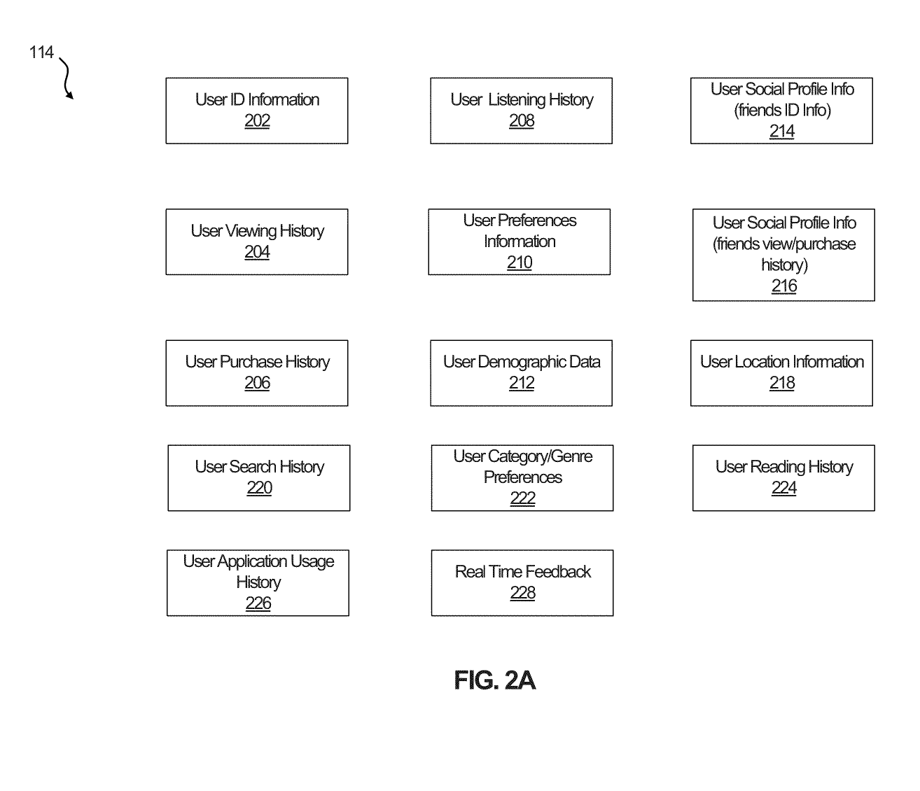

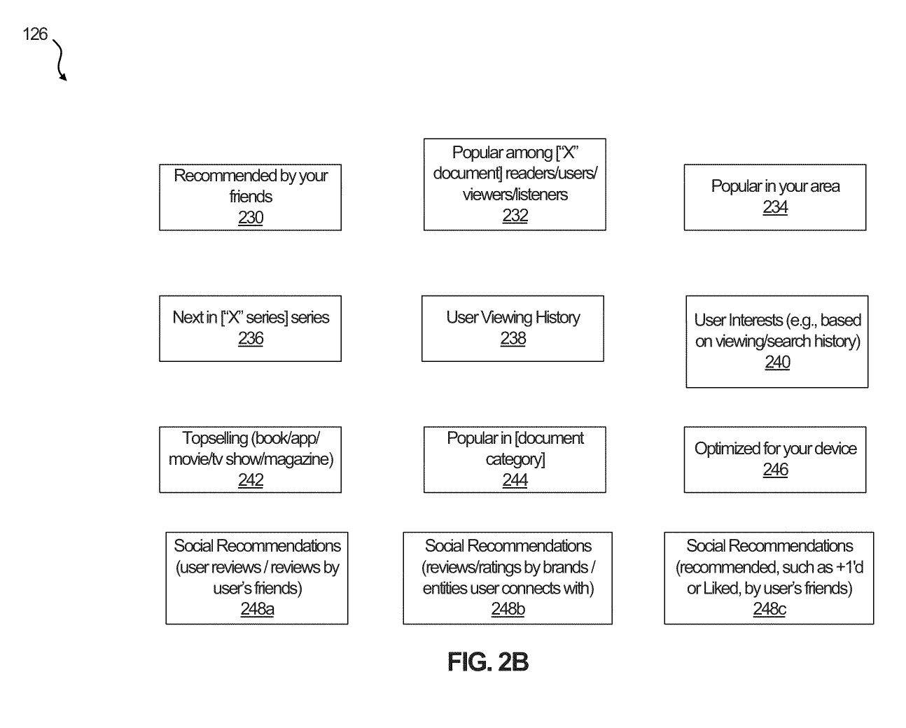

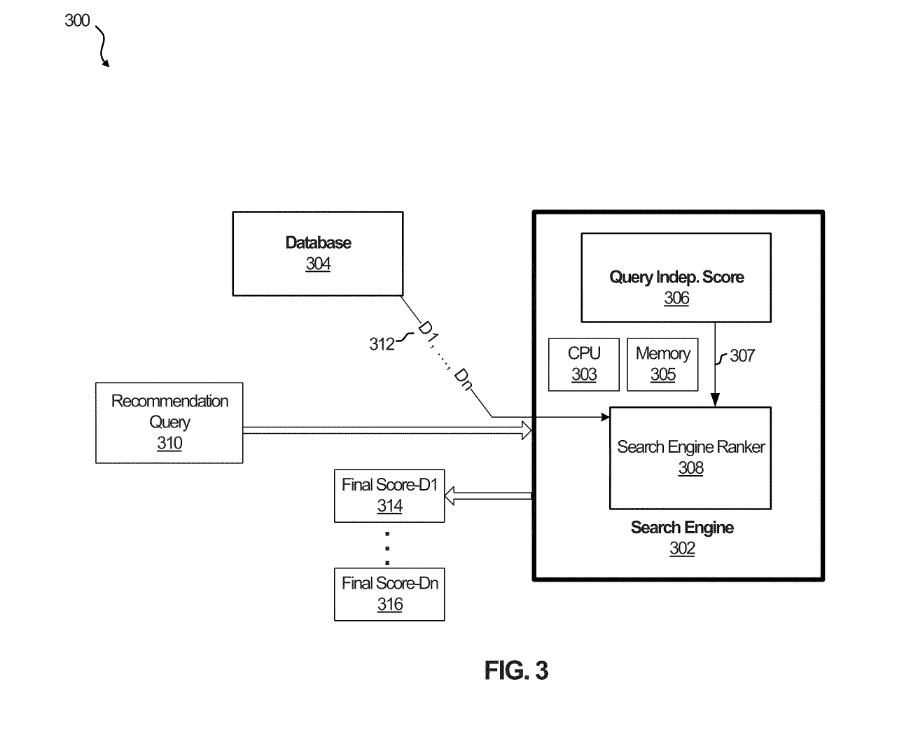

The document recommendation queries used to retrieve documents by the backend servers 108a, . . . , 112n may be associated with a plurality of candidate recommendation explanations and user contexts 126. Such recommendation explanations and user contexts 126 may be based on, for example, previous purchases of the user, the user's age, the user's gender, the user's location, the user's browsing/viewing/listening history, previous recommendations of documents by the user or friends in the user's social circles, etc. (further examples of explanations are provided in reference to FIG. 2B). The ordering of the recommendations (or documents) (e.g., as explained in reference to FIG. 3) may be based on an algorithm that combines the presence and strength of each of these signals. A similar algorithm may be used (e.g., by the explanation generation engine 124) to calculate the engagement likelihood of a user given a certain explanation.

The user engagement history database 122 may comprise suitable circuitry, logic and/or code and may store user engagement history received via communication path 120f from the frontend server 104. The user engagement history may comprise data associated with the preference of one or more users for a given explanation when selecting a recommendation. For example, the user engagement history may include data on popularity of explanations selected by the current user and/or other users, as well as data regarding popularity of a given document when selected under two or more different explanations (i.e., data indicating that the same document is more popular among users when presented with one explanation vs. when presented with another explanation). The user engagement history may be communicated to the explanation generation engine 124 using the communication path 120g.

The explanation generation engine 124 may comprise suitable circuitry, logic and/or code and may be operable to receive one or more explanations and user contexts 126 from the recommendation engine 106, and determine a final explanation (or a final ranked list of explanations) for use with a given retrieved document (or group of documents) based on the user engagement history received from the database 122.

The backend servers 108a, . . . , 112n may comprise suitable circuitry, logic and/or code and may be operable to provide, for example, searching and document retrieval functionalities. In this regard, one or more of the backend servers 108a, . . . , 112n may be associated with a respective corpus (e.g., corpus 1, . . . , N) comprising documents of certain type. For example, corpus 1 may be associated with backend servers 108a, . . . , 108n, and may comprise music-related items (e.g., music tracks, albums, etc.). Corpus 2 may be associated with backend servers 110a, . . . , 110n and may comprise applications (or apps) related documents. Corpus N may be associated with backend servers 112a, . . . , 112n and may comprise books related documents.

Even though the recommendation engine 106 is illustrated separate from the frontend server 104 and the backend servers 108a, . . . , 112n, the present disclosure may not be limited in this regard. More specifically, the recommendation engine 106 may be implemented as part of the frontend server 104 or one of the backend servers 108a, . . . , 112n.

In operation, the user 102 may provide user credentials (e.g., login information, password, etc.) to the frontend server 104 for logging in to a media-related service provided by the frontend server 104. The frontend server 104 may communicate the user 102 credentials to the recommendation engine 106 via communication path 120a, along with a request for a document recommendation. The recommendation engine 106 may then use the received user credentials (i.e., user identity information) as a first pass query to the user information database 114 (via the communication path 120c). In response to the query, the database 114 may return user-related information back to the recommendation engine 106 (e.g., information about user's friends, user's content consumptions, any information about the user that user 102 has previously provided to the frontend server 104, or information that may be inferred from the available user data, user location, etc.). More specific examples of user-related information are provided herein below in reference to FIG. 2.

In this regard, a “scatter gather” system may be implemented by using the recommendation engine 106 as the initiating single server (or a “root”), which may be operable to generate and communicate at least one document recommendation request or query to the plurality of backend servers (or “leaves”) 108a, . . . , 112n associated with a corpora (e.g., corpus 1, . . . , corpus N) of documents. The recommendation engine 106 may then generate one or more document recommendation requests or queries based on the received user-related information, and may send the document recommendation queries to the backend servers 108a, . . . , 112n (i.e., a “scatter step”). The backend servers 108a, . . . , 112n may each perform a search and retrieve candidate content for user recommendations. The retrieved documents may be returned back to the recommendation engine 106, which may use the user-related data to score and rank the received documents in order to generate a final list of recommendations for the user (i.e., the “gather” step). In the alternative, each of the backend servers 108a, . . . , 112n may retrieve and score/rank documents in response to the document recommendation queries received from the recommendation engine 106. After the scoring/ranking of retrieved documents, the top documents from each backend server 108a, . . . , 112n may be returned to the recommendation engine 106. The final list may be further mixed by the recommendation engine 106 so that recommendations from multiple document types (e.g., apps, music, videos, books, etc.) are present in the final list of recommendations.

After the recommendation engine generates the document recommendation queries, the explanations and user contexts 126 associated with the document recommendation queries may be communicated to the explanation generation engine 124. The explanation generation engine 124 may rank the explanations by assigning weights. For example, a higher weight value may be assigned to an explanation that has been popular with the current user and/or other users, based on the user engagement history data from the database 122. A higher weight value may also be assigned to a given explanation based on a popularity of the associated document recommendation.

For example, a given document recommendation may be retrieved based on two (or more) different document recommendation queries and, therefore, two or more corresponding explanations. However, the same document recommendation may be more popular (i.e., selected more number of times) under one of the explanations than being selected under another explanation. In this regard, the explanation associated with a more popular document selection may be given a higher weight. After the explanation generation engine 124 ranks the explanations, a ranked explanations list (or a top-ranked explanation) may be returned to the recommendations engine 106. The recommendation engine 106 may then provide the retrieved document recommendation along with the top-ranked explanation to the frontend server 104 using communication path 120d, for presentation to the user 102. The recommendation list and explanation generation functionalities described herein may be performed in real time (e.g., upon logging in of the user 102 into the media-related services provided by the frontend server 104) and may be updated periodically.

For example, if a user has a very strong history of watching action and adventure movies, retrieved documents associated with this type of movies will be presented with “Based on your interest in Action and Adventure movies” explanation. However, if the user is currently located in New York city, then documents may be retrieved based on popularity in specific geographic location (e.g., New York city). In this case, the retrieved documents may be presented with a “Popular in New York” explanation (even if there is another possible explanation, such as “Popular among users of New York Metro app” explanation) because the context of the user and user engagement history may indicate that the location-based explanation is more popular among similar users visiting New York city.

In some instances (e.g., upon selection of a specific document explanation), the frontend server 104 may communicate to the recommendation engine 106 the selected document explanation. The recommendation engine 106 may then filter retrieved documents based on the explanation, so that only documents satisfying the selected explanation are communicated back to the frontend server 104 for presentation to the user 102.

FIG. 2A is a block diagram illustrating an example database with user-related information, which may be used during the live recommendation and explanation generation illustrated in FIG. 1, in accordance with an example embodiment of the disclosure. Referring to FIG. 2A, there is illustrated a more detailed diagram of the user information database 114. More specifically, the user information database may comprise user identification information 202, information on user's viewing history 204, information on user's purchase history 206 (e.g., purchase of apps, music, videos, movies, books, etc.), and information on user's listening history 208 (e.g., listening history of music stored in user's cloud-based media locker).

The user information database 114 may also comprise user preferences information 210 (e.g., information provided by the user regarding preferred media genre, preferred media type, preferred artists/authors, etc.), user demographic data 212, and user location information 218. The user information database 114 may also comprise user social profile information 214 (e.g., information on user's friends in a social network) and 216 (e.g., information on the user's friends' viewing/purchase history).

The user information database 114 may further include user search history 220, user category/genre preferences 222, user reading history 224, user application usage history 226, and real time feedback information 228. The real time feedback information 228 may comprise recommendation dismissals, recommendation conversions (clicking on a recommendation or buying/installing the recommendation), recommendation approval information (+1, Like, etc.), and recommendation saving (e.g., via a wishlist feature).

Even though only fourteen types of information are illustrated in FIG. 2A, the present disclosure may not be limited in this regard and other types of user-related information may also be provided by the database 114.

Referring to FIGS. 1-2A, after the recommendation engine 106 receives user-related information from the database 114, it may then generate one or more document recommendation queries based on the received user-related information, and may send the document recommendation queries to the backend servers 108a, . . . , 112n. For example, if the user-related information comprises user viewing history 204 and/or purchase history 206 and/or listening history 208, the document recommendation queries may comprise document similar to what was viewed and/or purchased and/or listened to by the user. If the user-related information comprises user demographic data 212 and/or user location data 218, the document recommendation queries may comprise document popular to the user demographic (e.g., documents popular by other users that are same age as the user 102) and/or documents popular in the specific geographic location of the user.

FIG. 2B is a block diagram illustrating example explanations/user contexts, which may be used during the live recommendation and explanation generation illustrated in FIG. 1, in accordance with an example embodiment of the disclosure. Referring to FIG. 2B, there is illustrated a more detailed diagram of the explanations/user contexts 126. More specifically, the explanations/user contexts 126 may comprise explanation/user context information associated with the user, such as “recommended by your friends” explanation 220, “user viewing history” explanation 228 (may also include user's listening or reading history), and “user's interests” explanation 230 (e.g., based on viewing/search history).

The candidate recommendation explanations and user contexts 126 may also comprise “popular among [document name] readers/listeners/users/viewers” explanation 222, “popular in your area” explanation 224, “next in [series name] series” explanation 226, “top selling book/app/movie/tv show/magazine” explanation 232, “popular in [document category]” explanation 234, and “optimized for your device” explanation 236.

The candidate recommendation explanations and user contexts 126 may also comprise social recommendations 248a-248c. More specifically, the candidate recommendation explanations and user contexts 126 may also comprise recommendations 248a associated with user reviews and/or reviews by user's friends, recommendations 248b associated with reviews/ratings by brands/entities the user connects with, and/or recommendations 248c associated with recommended (such as +1′d or Liked) by user's friends.

Even though only nine types of explanations are illustrated in FIG. 2B, the present disclosure may not be limited in this regard and other types of explanations or user contexts may also be provided by the recommendation engine 106.

FIG. 3 is a block diagram illustrating a backend server architecture, which may be used during the live recommendation and explanation generation illustrated in FIG. 1, in accordance with an example embodiment of the disclosure. Referring to FIG. 3, the example backend server architecture 300 may comprise a search engine 302 and a document database (or corpus) 304.

The document database 304 may comprise suitable circuitry, logic and/or code and may be operable to provide documents of a specific type (e.g., song tracks, videos, books, movies, apps, etc.).

The search engine 302 may comprise suitable circuitry, logic and/or code and may be operable to receive database documents (e.g., documents 312, D1, . . . , Dn) in response to recommendation query 310 from the recommendation engine 106, and rank the received documents 312 based on the document final scores 314, . . . , 316. The search engine 302 may comprise a CPU 303, a memory 305, a query independent score module 306, and a search engine ranker 308.

The query independent score module 306 may comprise suitable circuitry, logic and/or code and may be operable to calculate a query-independent score (e.g., a popularity score) 307 for one or more documents received from the database 304. For example, the query-independent score may comprise a popularity score based on the number of search queries previously received within the backend server architecture 300 about a specific document from the database 304, as well as at least one of query-to-click ratio information and clickthrough ratio (CTR) information for at least one web page search result for the specific document.

The search engine ranker 308 may comprise suitable circuitry, logic and/or code and may be operable to receive one or more documents 312 (e.g., documents D1, . . . , Dn) in response to a document recommendation query 310. The search engine ranker 308 may then rank the received documents 312 based on a final ranking score 314, . . . , 316 calculated for each document using one or more query independent scores 307 (received from the query independent score module 306) and/or one or more query dependent scores. The search engine ranker may generate the final ranking score 314, . . . , 316 for each document based on the query-dependent and/or query-independent scores.

In operation, the recommendation engine 106 may communicate a document recommendation query 310 to the search engine 302. The document recommendation query 310 may be based on the user-related information received by the recommendation engine 106 from the database 114. After the search engine 302 receives the recommendation query 310, the search engine 302 may obtain one or more documents 312 (D1, . . . , Dn) that satisfy the recommendation query 310.

After the search engine 302 receives the documents 312, a query-independent score 307 may be calculated for each of the documents, and the score may be used by the ranker 308 to calculate the final ranking scores 314, . . . , 316 for the documents and output a ranked document search results list back to the recommendation engine 106.

Even though the search engine 302 and the database 304 are all illustrated as separate blocks, the present disclosure may not be limited in this regard. More specifically, the database 304 may be part of, and implemented within, the search engine 302 with all processing functionalities being controlled by the CPU 303. The CPU 303 may be operable to perform one or more of the processing functionalities associated with retrieving and/or ranking of documents, as disclosed herein.

In accordance with an example embodiment of the disclosure, all ranking/scoring functionalities for documents retrieved in response to the document recommendation query 310 may be performed by the recommendation engine 106. In this regard, the backend server architecture 300 (which is representative of one or more of the backend servers 108a, . . . , 112n) may perform the document retrieval functionalities, and ranking/scoring functionalities may be performed after the retrieved documents are communicated back to the recommendation engine 106.

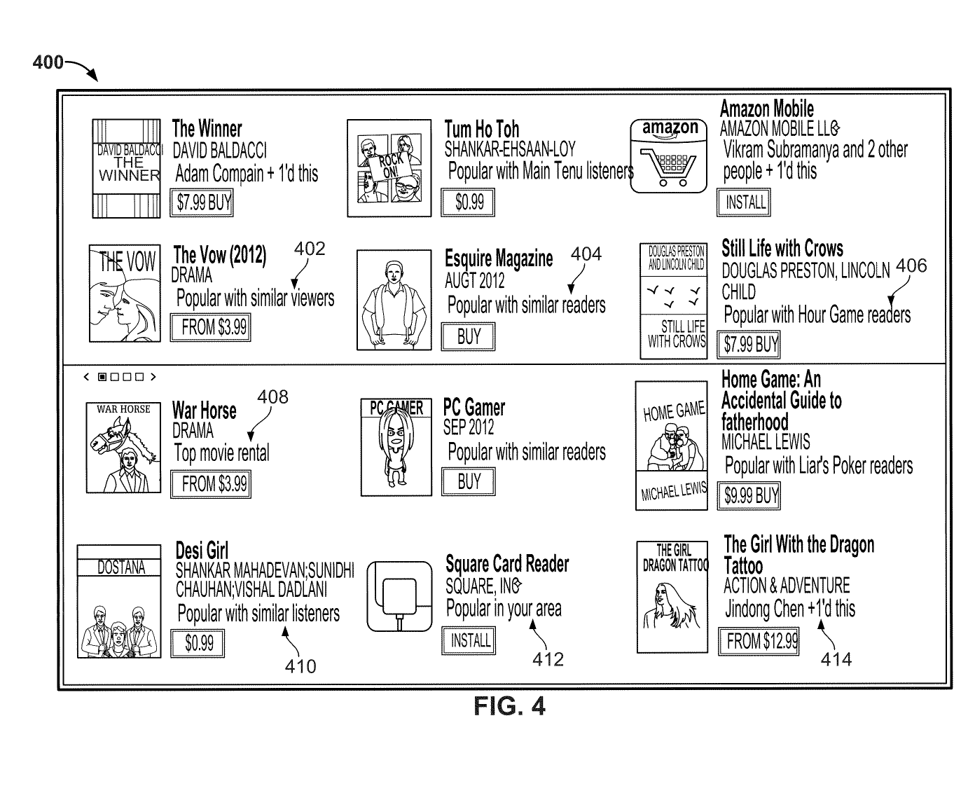

FIG. 4 is a diagram illustrating example user recommendations with explanations, in accordance with an example embodiment of the disclosure. Referring to FIG. 4, there is illustrated a plurality of example document recommendations 400, including explanations. Explanation “popular with similar viewers” 402 may be used to recommend movies/videos/tv shows that are popular with viewers of the recommended document.

Explanation “popular with similar readers” 404 may be used to recommend books/magazines that are popular with readers of the recommended document. Explanation “popular with [document name] readers” 406 may be used to recommend books/magazines that are popular with readers of the recommended document [document name]. Explanation “top movie rental 408 may be used to recommend movies that are popular with movie viewers. Explanation “popular with similar listeners” 410 may be used to recommend music albums that are popular with listeners of the recommended document. Explanation “popular in your area” 412 may be used to recommend apps/books/magazines (or other document types) that are popular with users (of the recommended document) in your area. Explanation “Recommended by [another user]” 414 (or “+1′d by [another user]”) may be used to recommend documents that are popular with the [another user] (e.g., someone in the user's social circles).

As explained above, after a user selects a recommendation explanation (e.g., one of the explanations 402-414), the selected explanation may be communicated from the frontend server 104 to the backend server 106. The backend server 106 may then filter retrieved documents so that only documents that fit the selected explanation are returned back to the frontend server via communication path 120d, for presentation to the user 102.

In instances when the frontend server 104 operates an online media store, one or more recommendations may be provided to the user 102 upon checkout. For example, a purchase receipt presented to the user 102 may include “People who bought this also bought . . . ” style of recommendations. The “people who bought this also bought . . . ” style of recommendations may also be presented in the online media store, as the user is browsing through available media items for download/sale.

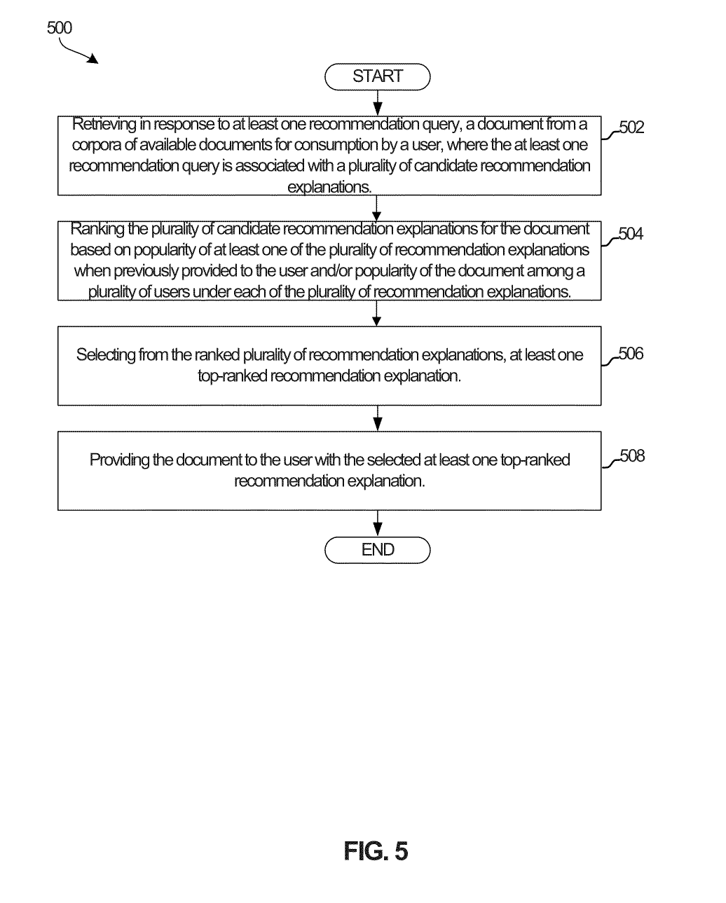

FIG. 5 is a flow chart illustrating example steps of a method for providing recommendations with explanations to a user, in accordance with an example embodiment of the disclosure. Referring to FIGS. 1-5, the example method 500 may start at 502, when in response to at least one recommendation query (e.g., generated by the recommendation engine 106), the backend servers 108a, . . . , 112n may retrieve a document from a corpora of available documents (e.g., corpus 1, . . . , N) for consumption by a user. The at least one recommendation query may be associated with a corresponding recommendation explanation (e.g., one or more of the explanations 126).

At 504, the explanation generation engine 124 may rank the plurality of recommendation explanations for the document based on popularity of at least one of the plurality of recommendation explanations when previously provided to the user and/or popularity of the document among a plurality of users under each of the plurality of recommendation explanations (e.g., user engagement history from the database 122). At 506, the explanation generation engine 124 may select from the ranked plurality of recommendation explanations, at least one top-ranked recommendation explanation, which may be provided back to the recommendation engine via wired and/or wireless communication path 120e. At 508, the recommendation engine 106 may provide the retrieved document to the frontend server 104 and then to user 102 with the selected at least one top-ranked recommendation explanation.

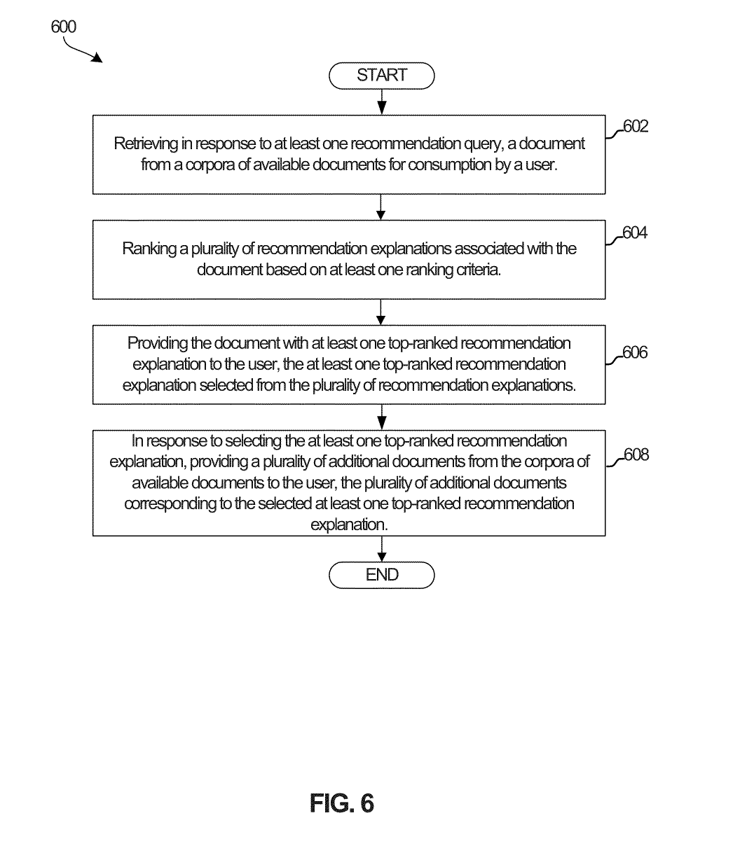

FIG. 6 is a flow chart illustrating example steps of another method for providing recommendations with explanations to a user, in accordance with an example embodiment of the disclosure. Referring to FIGS. 1-6, the example method 600 may start at 602, when in response to at least one recommendation query (e.g., generated by the recommendation engine 106 and communicated to the backend servers 108a, . . . , 112n), a document may be retrieved from a corpora of available documents (e.g., corpus 1, . . . , N) for consumption by a user 102.

At 604, the explanation generation engine 124 may rank a plurality of recommendation explanations (e.g., explanations 124) associated with the document based on at least one ranking criteria. At 606, the explanation generation engine 124 may provide at least one top-ranked recommendation explanation to the recommendation engine 126. The recommendation engine 126 may provide the document with the at least one top-ranked recommendation explanation to frontend server 104 (via wired and/or wireless communication path 120d) for presentation to the user 102. The at least one top-ranked recommendation explanation may be selected by the explanation generation engine 124 from the plurality of recommendation explanations 126.

At 608, in response to selecting the at least one top-ranked recommendation explanation (e.g., by the user 102), a plurality of additional documents from the corpora of available documents may be provided back to the user. The plurality of additional documents may correspond to the selected at least one top-ranked recommendation explanation.

Other implementations may provide a machine-readable storage device, having stored thereon, a machine code and/or a computer program having at least one code section executable by a machine and/or a computer, thereby causing the machine and/or computer to perform the steps as described herein for providing recommendations to a user.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method for providing recommendation explanations, comprising:
retrieving in response to at least one recommendation query, a document from a corpora of available documents for consumption by a user, wherein:
the at least one recommendation query is associated with a plurality of candidate recommendation explanations; and
ranking the plurality of candidate recommendation explanations for the document based on one or both of:
popularity of at least one of the plurality of candidate recommendation explanations when previously provided to the user; and
popularity of the document among a plurality of other users under each of the plurality of candidate recommendation explanations.

2. The method according to claim 1, wherein each corpus in the corpora classifies a plurality of documents of a determined type available for consumption by a user.

3. The method according to claim 1, wherein the popularity of at least one of the plurality of recommendation explanations previously provided to the user is based on document engagement history associated with the user when the at least one of the plurality of recommendation explanations were previously provided to the user.

4. The method according to claim 3, wherein the popularity of at least one of the plurality of recommendation explanations previously provided to the user is further based on document engagement history associated with a plurality of other users when the at least one of the plurality of recommendation explanations were previously provided to the plurality of other users.

5. The method according to claim 4, wherein the document engagement history for a corresponding recommendation explanation comprises prior consumption history of at least one document, when the at least one document is presented to the user or the plurality of other users with the corresponding recommendation explanation.

6. The method according to claim 1, wherein:
the popularity of the at least one of the plurality of recommendation explanations is based on a total number of consumptions of documents previously recommended to the user using the at least one of the plurality of recommendation explanations; and
the popularity of the document among a plurality of users under each of the plurality of recommendation explanations is based on a total number of consumptions of the document by the plurality of users when the document is provided to the plurality of users using each of the plurality of recommendation explanations.

7. The method according to claim 1, comprising:
selecting from the ranked plurality of recommendation explanations, at least one top-ranked recommendation explanation; and
providing the document to the user with the selected at least one top-ranked recommendation explanation.

8. A system for providing recommendation explanations, comprising:
a network device comprising at least one processor coupled to a memory, the at least one processor operable to:
retrieve in response to at least one recommendation query, a document from a corpora of available documents for consumption by a user, wherein the at least one recommendation query is associated with a corresponding plurality of candidate recommendation explanations; and
rank the plurality of candidate recommendation explanations for the document based on one or both of:
popularity of at least one of the plurality of candidate recommendation explanations when previously provided to the user; and
popularity of the document among a plurality of users under each of the plurality of candidate recommendation explanations.

9. The system according to claim 8, wherein each corpus in the corpora classifies a plurality of documents of a determined type available for consumption by a user.

10. The system according to claim 8, wherein the popularity of at least one of the plurality of recommendation explanations previously provided to the user is based on document engagement history associated with the user when the at least one of the plurality of recommendation explanations were previously provided to the user.

11. The system according to claim 10, wherein the popularity of at least one of the plurality of recommendation explanations previously provided to the user is further based on document engagement history associated with a plurality of other users when the at least one of the plurality of recommendation explanations were previously provided to the plurality of other users.

12. The system according to claim 11, wherein the document engagement history for a corresponding recommendation explanation comprises prior consumption history of at least one document, when the at least one document is presented to the user or the plurality of other users with the corresponding recommendation explanation.

13. The system according to claim 8, wherein:
the popularity of the at least one of the plurality of recommendation explanations is based on a total number of consumptions of documents previously recommended to the user using the at least one of the plurality of recommendation explanations; and
the popularity of the document among a plurality of users under each of the plurality of recommendation explanations is based on a total number of consumptions of the document by the plurality of users when the document is provided to the plurality of users using each of the plurality of recommendation explanations.

14. The system according to claim 8, wherein the at least one processor is operable to:
select from the ranked plurality of recommendation explanations, at least one top-ranked recommendation explanation; and
provide the document to the user with the selected at least one top-ranked recommendation explanation.

15. A method for providing recommendation explanations, comprising:
retrieving in response to each of a plurality of recommendation queries, a document from a corpora of available documents for consumption by a user;
ranking a plurality of candidate recommendation explanations associated with the document based on at least one ranking criteria;
providing the document with at least one top-ranked recommendation explanation to the user, the at least one top-ranked recommendation explanation selected from the plurality of candidate recommendation explanations; and
in response to selecting the at least one top-ranked recommendation explanation, providing a plurality of additional documents from the corpora of available documents to the user, the plurality of additional documents corresponding to the selected at least one top-ranked recommendation explanation.

16. The method according to claim 15, wherein the recommendation explanations are generated based on the plurality of recommendation queries.

17. The method according to claim 15, comprising ranking the plurality of recommendation explanations associated with the document based on one or both of:
popularity of at least one of the plurality of recommendation explanations when previously provided to the user; and
popularity of the document among a plurality of users under each of the plurality of recommendation explanations.

18. The method according to claim 17, wherein the popularity of the at least one of the plurality of recommendation explanations previously provided to the user is based on one or both of:
document engagement history associated with the user when the at least one of the plurality of recommendation explanations were previously provided to the user; and/or
document engagement history associated with a plurality of other users when the at least one of the plurality of recommendation explanations were previously provided to the plurality of other users.

19. The method according to claim 15, wherein the top-ranked recommendation explanation is associated with a determined one of the plurality of recommendation queries used for retrieving the document.

20. The method according to claim 19, comprising:
retrieving the plurality of additional documents from the corpora of available documents using the determined one of the plurality of recommendation queries.
